(19) United States
(12) Patent Application Publication
(10) Pub. No.: US 2007/0148365 A1
(43) Pub. Date: Jun. 28, 2007

(54) Process and apparatus for coating paper

(76) Inventors: David E. Knox, Goose Creek, SC (US); Edward P. Klein, Goose Creek, SC (US); Vladislav A. Babinsky, Grove City, OH (US); Sharon Wall Klein, Goose Creek, SC (US)

Correspondence Address: THOMPSON HINE L.L.P., P.O. BOX 8801, DAYTON, OH, 45401-8801, US

(21) Appl. No.: 11/320,150

(22) Filed: Dec. 28, 2005

(51) Int. Cl. B05D 1/16; D21H 19/00

(52) U.S. Cl. 427/462; 162/135; 162/164.1; 162/158

(57) ABSTRACT

A method for forming paper or paperboard includes applying a plurality of nanofibers to a web of cellulose paper fibers using an electrospinning device comprising a plurality of meniscus initiators. The paper or paperboard may also be coated with a top coating to provide desired print properties.

### BACKGROUND OF THE INVENTION

The present invention relates to a method for coating a web of paper or paperboard. More particularly, the invention relates to a paper or paperboard coating method comprising the steps of contacting a plurality of meniscus initiators with a fiber-forming composition thereby forming areas of concentrated charge in the fiber-forming composition, forming fibers at the areas of concentrated charge by electrostatically drawing the fiber-forming composition toward a first electrode and depositing the fibers on a base sheet positioned between the fiber-forming composition and the first electrode.

Paper is manufactured by an essentially continuous production process wherein a dilute aqueous slurry of cellulosic fiber flows into the wet end of a paper machine and a consolidated dried web of indefinite length emerges continuously from the paper machine dry end. The wet end of the paper machine comprises one or more headboxes, a drainage section and a press section. The dry end of a modern paper machine comprises a multiplicity of steam heated, rotating shell cylinders distributed along a serpentine web traveling route under a heat confining hood structure. Although there are numerous design variations for each of these paper machine sections, the commercially most important of the variants is the fourdrinier machine wherein the headbox discharges a wide jet of the slurry onto a moving screen of extremely fine mesh.

The screen is constructed and driven as an endless belt carried over a plurality of support rolls or foils. A pressure differential across the screen from the side in contact with the slurry to the opposite side draws water from the slurry through the screen while that section of the screen travels along a table portion of the screen route circuit. As slurry dilution water is extracted, the fibrous constituency of the slurry accumulates on the screen surface as a wet but substantially consolidated mat. Upon arrival at the end of the screen circuit table length, the mat has accumulated sufficient mass and tensile strength to carry a short physical gap between the screen and the first press roll. This first press roll carries the mat into a first press nip wherein the major volume of water remaining in the mat is removed by roll nip squeezing. One or more additional press nips may follow.

From the press section, the mat continuum, now generally characterized as a web, enters the dryer section of the paper machine to have the remaining water removed thermodynamically.

Generally speaking, the most important fibers for the manufacture of paper are obtained from softwood and hardwood tree species. However, fibers obtained from straw or bagasse have been utilized in certain cases. Both chemical and mechanical defiberizing processes, well known to the prior art, are used to separate papermaking fiber from the composition of natural growth. Papermaking fiber obtained by chemical defiberizing processes and methods is generally called chemical pulp whereas papermaking fiber derived from mechanical defiberizing methods may be called groundwood pulp or mechanical pulp. There also are combined defiberizing processes such as semichemical, thermochemical or thermomechanical. Either of the tree species may be defiberized by either chemical or mechanical methods. However, some species and defiberizing processes are better economic or functional matches than others.

An important difference between chemical and mechanical pulp is that mechanical pulp may be passed directly from the defiberizing stage to the paper machine. Chemical pulp on the other hand must be mechanically defiberized, washed and screened, at a minimum, after chemical digestion. Usually, chemical pulp is also mechanically refined after screening and prior to the paper machine. Additionally, the average fiber length of mechanical pulp is, as a rule, shorter than that of chemical pulp. However, fiber length is also highly dependent upon the wood species from which the fiber originates. Softwood fiber is generally about three times longer than hardwood fiber.

The ultimate properties of a particular paper are determined in large part by the species of raw material used and the manner in which the paper machine and web forming process treat these raw materials. Important operative factors in the mechanism of forming the paper web are the headbox and screen.

The particular fiber material or stock from which the paper is manufactured is, by nature, generally highly nonhomogeneous with respect to both the length and the thickness of the fibers. The longest fibers are typically of an order of about 2 to 3 mm, while the shortest fibers typically are about 1/10 of this length. Only a few paper grades are produced by using a single fiber type alone. In most cases, at least two kinds of fiber are used for paper.

Paper or paperboard may be coated to modify or improve various properties. Coated paper or paperboard used for printing and for packaging is generally required to have high level of gloss, excellent smoothness, and excellent printability, as well as certain strength and stiffness characteristics.

Applying a paper coating is a very common way to enhance the surface properties of paper. However, paper-coating equipment can be very complex and expensive. Typically, coating weights from about 2-6 lbs./1000 ft² are required to substantially enhance surface properties of the paper. Such a relatively high coat weight can result in substantial expenses with respect to coating materials and result in an increase in the basis weight of the finished paper. A high coat weight is usually required because lower coating weights are typically not uniform enough to provide the desired improvement in surface properties. Non-uniformity associated with low coating weights can be particularly problematic when coating unbleached board. Because of the brown fibers in the unbleached board, it is particularly desirable that the coating, which is typically white, cover the brown board completely. Preferably, the final coated surface should be uniform to provide acceptable appearance and printing properties.

Stiffness has close relationship to the basis weight of paper and density. There is a general trend that stiffness increases as the basis weight increases, and decreases as the paper density increases. Stiffness and other properties can be improved by increasing basis weight. However, this would result in a product utilizing more fibers, which add cost and weight. Therefore, coated paper or paperboard with high stiffness but moderate basis weight is desirable. Paper with moderate basis weight is also more economical because less raw material (fiber) is utilized. In addition, shipping costs based on weight are less for low basis weight paper.

In addition to high stiffness, coated paper or paperboard which must be printed is often required to have high gloss and smoothness. For coated paper or paperboard to have such quality characteristics, density typically must be increased to some extent to allow for a usable printing surface. Smoothness is normally achieved by calendering. However, calendering will cause a reduction in caliper, which typically results in a corresponding reduction in stiffness. The calendering process deteriorates the stiffness of paper by significantly reducing caliper.

Thus, the relationship between gloss and stiffness and between smoothness and stiffness are generally inversely proportional to each other, for a given amount of fiber per unit area.

Improvements in the calendering process including moisture gradient calendering, hot calendering, soft calendering, and belt calendering slightly improved stiffness for a given caliper but did not change the fundamental ratio between caliper, stiffness, smoothness, and printing properties.

For the reasons mentioned above, it has been very difficult to obtain satisfactory paper stiffness and paper smoothness using less fiber. Other methods can be used for changing the stiffness/smoothness relationship in paper and paperboard grades. The primary means of doing this is by the manufacture of multi-ply paperboard. In this technique, fibers which provide a bulky structure such as thermomechanical pulp (TMP), or chemithermomechanical pulps (CTMP), are used in the base ply of a sheet. The top ply generally consists of a chemical pulp which is susceptible to the effects of calendering and provides smoothness. A chief drawback to multi-ply paperboard is the requirements to handle multiple fiber streams and the very high capital required to install multi-ply paper machines.

One method that has recently been explored to address these issues has been the use of an electrospinning process to form a light-weight secondary fibrous web attached to a primary paper web to provide good appearance, smoothness, and print quality with optical density of prints while reducing the weight of paper and production costs. Electrospinning technology refers to a room temperature technique that can be used to apply a uniform web of nanofibers over the surface of a substrate at atmospheric pressures. The electrospinning process can be used to incorporate various types of fibers, such as polymeric, metaloxide, or metaloxide/polymeric composite nanofibers directly onto or incorporated into the surface of paper.

Electrospinning (electrostatic spinning) is a process based on the use of high voltages (e.g., 5-100 kV) to generate ultra fine fibers with diameters in the range of about 10 nm to 500 microns. This technology utilizes an electric field to generate sufficient surface charge to overcome the surface tension in a viscous drop of polymer melt, solution, and/or gel. This creates a jet of solution that comes from an orifice that is drawn down by acceleration to a grounded collection device located on the other side of the web. In a conventional electrospinning device, the fiber-forming composition is discharged from jets or slot located on the side of the moving paper web opposite the grounded collection device. The discharging component of the electrospinning device typically is a manifold with a number of nozzles having round orifices. In order to use the electrospinning device to coat paper on a high-speed paper machine, a relatively large number of nozzles would be required to provide the necessary level of nanofiber production to adequately coat the paper being produced at high speeds. Runability and productivity problems can be encountered with such a large number of nozzles because of the tendency for the nozzles to clog during a production run.

The discharging component of a conventional electrospinning device typically includes a plurality of nozzles or the discharging component can be in the shape of a slot. Typical cross sectional areas for electrospinning nozzles can range from about 0.1 mm² to about 10 mm² and can be of any usable shape although the nozzles are typically round. Discharging components having a slot shape typically have a width of between about 10-1000 microns. One problem with the use of electrospinning devices that utilize nozzles is that the nozzles can become clogged, thereby interfering with productivity and the ability to coat at high speeds such as on a paper machine. Typically, the diameter of the fibers produced by electrospinning are at least one order of a magnitude smaller and have larger surface area to volume ratios than fibers made by conventional extrusion techniques. Electrospinning is described in more detail in U.S. Pat. Nos. 2,158,416; 2,323,025; 6,641,773 and U.S. Pat. App. Pub. No. 2004/0223040, the disclosures of which are hereby incorporated by reference.

Therefore, it would be desirable to provide a paper or paperboard containing nanofibers using an electrospinning process capable of increased productivity and reduced downtime. Furthermore, it would be desirable to provide a paper or paperboard exhibiting improved properties without significantly increasing paper weight.

### SUMMARY OF THE INVENTION

The present invention relates to paper or paperboard coated with nanofibers. The invention also relates to methods for manufacturing the described paper or paperboard products using an electrospinning device comprising a plurality of meniscus initiators. In accordance with one aspect of the invention, a web of cellulose paper fibers is formed on a paper machine and a plurality of nanofibers are applied to the web of cellulose fibers to produce a coated paper comprising nanofibers applied to the base cellulose fiber web. In accordance with a particular embodiment of the invention, the nanofibers are directly applied to the web of cellulose paper fibers using an electrospinning device comprising a plurality of meniscus initiators. In accordance with a particular embodiment of the invention, a paper or paperboard is coated by contacting a plurality of meniscus initiators with a fiber-forming composition thereby forming areas of concentrated charge in the fiber-forming composition, forming fibers at the areas of concentrated charge by electrostatically drawing the fiber-forming composition toward a first electrode, and depositing the fibers on a base sheet positioned between the fiber-forming composition and the first electrode. In accordance with a particular embodiment of the invention, the electrospinning device comprises a plurality of meniscus initiators dispersed throughout a volume of fiber-forming composition. The meniscus initiators in accordance with certain embodiments comprise rods or shafts mounted in a tray containing the fiber-forming composition. Meniscus-initiating portions on the meniscus initiators cause meniscus formation on the surface of the fiber-forming composition as the fiber-forming composition contacts these portions of the meniscus initiators. The meniscus-initiating portions may be, for example, the upper surface of a rod, which may be flat, conical or rounded. The meniscus functions as an initial point for the electrospinning process as a concentration of electrical charges is formed and initiates fiber formation as the fiber-forming composition is drawn to the paper surface by the electrostatic field created by the electrodes.

In accordance with a particular embodiment of the invention, the electrospinning device can be designed similar to the head box of a paper machine wherein the meniscus initiators are positioned near the edge of a discharging slot where the fiber-forming composition is drawn through the electrostatic field to the paper surface.

In accordance with the present invention, the nanofibers are produced using a modified electrospinning device that can be used to apply a uniform web of nanofibers over the surface of a substrate. Electrospinning makes it possible to incorporate a variety of fibers such as polymeric, metaloxide, or metaloxide/polymeric composite nanofibers directly onto the surface of a paper. In accordance with certain aspects of the present invention, the nanofibers are applied to the forming paper web and coated with a conventional coating composition.

### BRIEF DESCRIPTION OF THE DRAWINGS

FIG. 1 is a schematic view of an electrospinning device in accordance with one aspect of the invention;

FIG. 2 is a top view of the tray and meniscus initiators of the device of FIG. 1;

FIG. 3 is a magnified cross section view of a meniscus initiator in the device of FIG. 1 showing the concentration of charge created by the meniscus;

FIG. 4 is a schematic view of an electrospinning device in accordance with another embodiment of the invention;

FIG. 5 is a lateral cross section view of the device of FIG. 4 showing the meniscus initiators; and

FIG. 6 is an alternative design for a meniscus initiator according to another aspect of the invention.

### DETAILED DESCRIPTION OF THE INVENTION

In describing a specific embodiment of the invention, certain terminology will be utilized for the sake of clarity. It is intended that such terminology include not only the recited embodiments but all technical equivalents that operate in a similar manner, for a similar purpose, to achieve a similar result. The citation of any document is not to be construed as an admission that it is prior art with respect to the present invention.

The present invention is directed to a method of coating a paper or paperboard with nanofibers. In accordance with certain embodiments, the nanofibers may form a nanoweb. The term “nanoweb” as used herein refers to one or more layers comprising nanofibers. The coated paper or paperboard may be formed by applying nanofibers to a web of cellulose paper fibers to produce a coated paper web comprising a nanoweb layer and a cellulose-fiber layer. In accordance with a particular embodiment of the invention, the nanofibers are produced using a modified electrospinning device on a paper machine. More particularly, the electrospinning device may be located in a certain zone of the paper machine where the dryness of the paper web will be favorable for application of nanofibers generated by electrospinning.

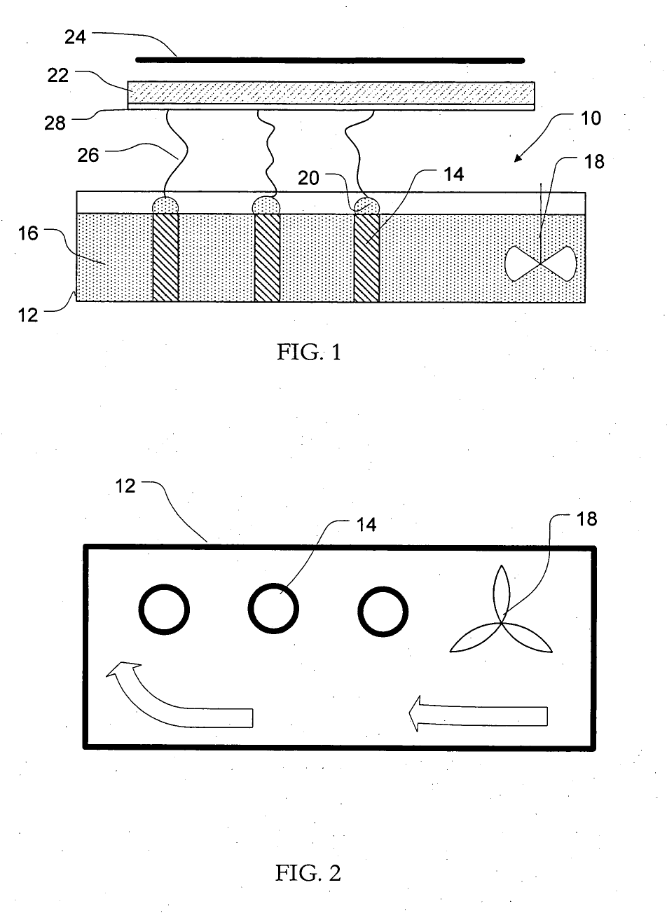

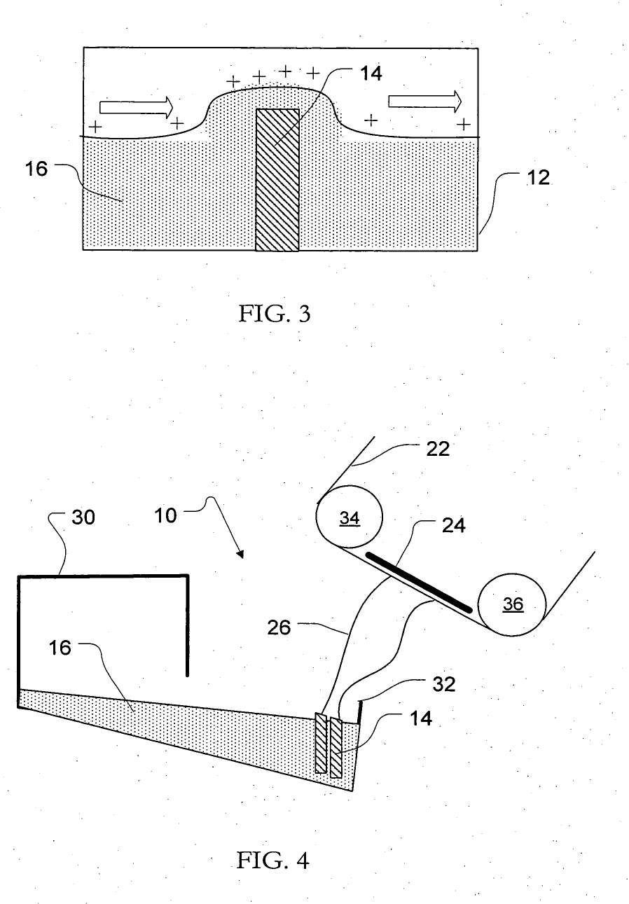

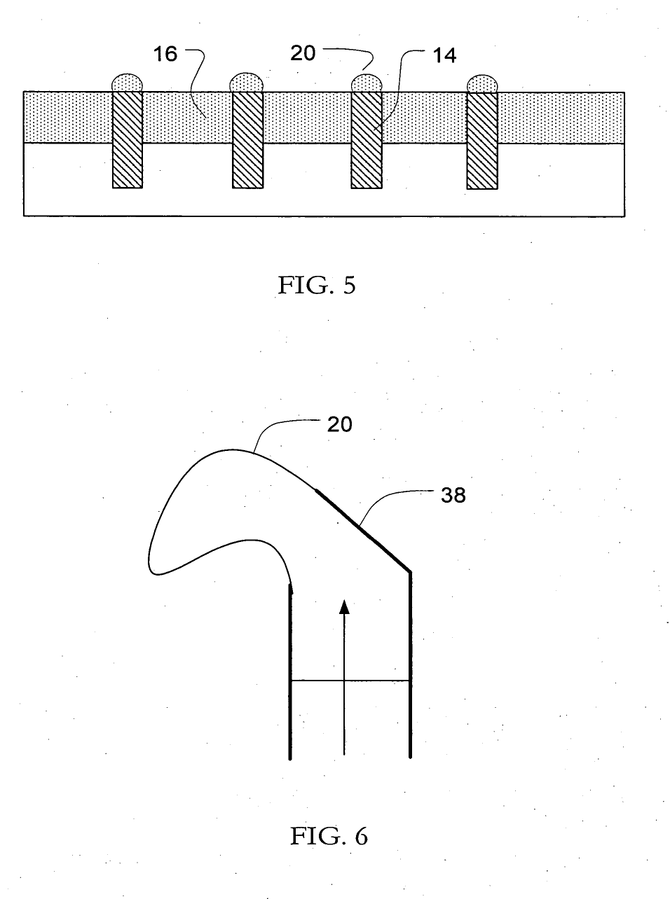

FIG. 1 illustrates a modified electrospinning device 10 for manufacturing a coated paper or paperboard in accordance with one aspect of the present invention. The electrospinning device 10 includes a tray 12 provided with a plurality of meniscus initiators 14. The tray 12 holds the fiber-forming composition 16 and typically is provided with a mixer 18. The mixer 18 causes the fluid-forming composition 16 to move over the meniscus initiators 14 forming a meniscus 20 on the surface thereof. FIG. 2 illustrates the flow pattern of the fiber-forming composition 16 as created by the mixer 18 in accordance with a specific embodiment of the invention. Similar to a conventional electrospinning device, an electromagnetic field is generated by applying external power from a power supply (not shown). High voltages (e.g., from about 5-100 kV) are used to generate ultra fine fibers with diameters in the range of about 10 nm to 500 microns. The electric field generates sufficient surface charge to overcome the surface tension in an area of concentrated charge as the polymer melt, solution, and/or gel moves over or around the meniscus initiator. This creates a jet of solution that comes from the fiber forming solution around or near the meniscus initiator that is drawn by acceleration to a grounded collection device located on the other side of the web. The fiber-forming composition is formed into fibers originating from the meniscus initiators located on the side of the moving paper web opposite the grounded collection device. As best shown in FIG. 3, creation of the meniscus 20 forms a concentration of charge around the meniscus 20. The area of concentrated charge at the meniscus 20 serves as the initial point for fiber formation as the fiber-forming composition 16 is drawn to a base paper 22 disposed between a first electrode 24 and the meniscus initiators 14 thereby forming a plurality of nanofibers 26 that are deposited on the base paper 22 as a coating of nanofibers 28.

One advantage associated with the electrospinning device illustrated in FIG. 1 relates to the formation of the nanofibers in an upward direction. The upward motion reduces or eliminates difficulties associated with dropping of the fiber-forming composition on a paper or paperboard that can be associated with conventional electrospinning coating applications. Conventional electrospinning devices that apply the fiber-forming compositions vertically from a position located above the web can frequently cause contamination of the web from fiber-forming composition falling from the electrospinning device on the web in a non-fiberized state. Any drops or splatters of fiber-forming composition that has not been formed into fibers can affect the uniformity and acceptability of the coated paper.

In accordance with another embodiment of the invention, the electrospinning device 10 may include a modified tray design 30, which is similar to the head box of a paper machine as shown in FIG. 4. In accordance with this design, the meniscus initiators 14 are installed near the edge of the discharging slot 32. The fiber-forming composition 16 flows over the meniscus initiators 14 thereby forming a meniscus 20 at each of the meniscus initiators 14. Each meniscus 20 corresponds to a concentration of charge in the fluid-forming composition 16, which initiates the fiber-forming process as the fiber-forming composition is drawn to the base paper surface 22 as a result of the first electrode 24 positioned on the opposing side of the base paper 22. Nanofibers of the fiber-forming composition 16 are deposited on the base paper 22 as the paper moves between rollers 34 and 36. The electrospinning device 10 in accordance with particular aspects of the present invention can be used to deposit nanofibers on a paper machine at high speeds up to about 3,000 feet per minute or more.

The meniscus initiators 14 may be in the form of vertical rods/shafts as shown in the drawings. However, the present invention is not limited to meniscus initiators in the shape of rods or shafts. Any structures capable of forming menisci in the fluid-forming composition such that an area of concentrated charge corresponds to the formed meniscus may be used as meniscus initiators in accordance with the present invention. Specific mention may be made of wire grids and protrusions from a wheel, needle or other structure. In accordance with one aspect of the invention as shown in FIG. 6, the meniscus initiator may be in the form of an upward capillary tube 38 having an angled cut to create an overflow of liquid, which forms a meniscus 20. The meniscus initiator in accordance with this aspect of the invention differs from the apertures used in accordance with conventional electrospinning devices, which are subject to clogging with extended use.

The rod-shaped meniscus initiators shown in the drawings typically will have a diameter from about 0.1 to about 20 mm, more particularly from about 0.2 to about 10 mm. The meniscus initiators may have a flat, conical or rounded upper surface to initiate meniscus formation. In operation, the fiber-forming composition for electrospinning is supplied to the tray 12 and overflow is removed from the tray. The circulation of liquid in the tray 12 will create a flow that will interact with the rods overflowing their upper surfaces. The liquid overflowing the rods will form a meniscus 20 on each meniscus initiator 14 that will serve as an initial point for the electrospinning process. The creation of an electromagnetic field is achieved by applying external power from a power supply similar to a conventional electrospinning device. A concentration of electrical charges occurs on the meniscus thereby initiating the electrospinning process as the area of concentrated charge in the fiber-forming composition is drawn to the electrode on the opposite side of the paper surface. Typically, there is contact and some friction between the paperweb and the electrode, thereby inducing a charge on the web as the web advances past the stationary electrode. The motion of the liquid in the tray can be controlled by the velocity of circulation. Additional means can also be used to control the velocity of the liquid including, but not limited to, the use of an impeller or vibrating blade.

The nanofibers and cellulose fibers should be adequately bonded to prevent separation during use. Sufficient bonding can typically be achieved by selection of an appropriate material for the nanofibers having a certain melting temperature and certain thermo-mechanical and hardening characteristics. However, selection of nanofiber materials meeting these conditions can essentially limit the materials that can be used with electrospinning technology. In accordance with certain aspects of the present invention, an increased number of materials can be used to form the nanofibers by installing the electrospinning device on the paper machine in the area of dryness from about 40% to 100% by weight, more particularly from about 50 to about 80% and in accordance with certain embodiments from about 55 to about 75%. Under these conditions, the contraction of fiber structure of the cellulose paper web during drying will help to secure the nanofibers in the fiber structure of the cellulose paper forming inner bonding between the paper web and the nanoweb. For example, the electrospinning device may be positioned at various points of the forming paper web. It may be positioned between or in place of one of the sets of press rolls or it may be located between the last press rolls and the dryer section. However, the present invention is not limited to application on a paper machine; coating a paper or paperboard as a separate operation is also within the scope of the present invention.

One advantage of providing a layer of nanofibers on a cellulose paper web is that calendering of the cellulose paper web is not typically required to produce a paper having the same print properties of conventional coated papers. Furthermore, even when the cellulose paper web is calendered, much lower pressures can be applied to provide similar printing properties on papers with increased stiffness. In accordance with certain aspects of the present invention, the cellulose paper web is calendered such that the caliper decreases not more than about 5% and typically is decreased by between about 2% and 5%. By comparison, conventional coated papers are typically calendered before coating at much higher pressures, which cause a decrease in caliper of from about 10 to 15%. In accordance with one aspect of the invention, the cellulose paper web may be calendered to a Parker Print smoothness of between about 2 and 6 microns prior to application of the nanoweb. Parker Print smoothness is determined in accordance with TAPPI standard T 555 om-99.

In accordance with a particular embodiment of the present invention, the electrospinning device is located in the drying section of the paper machine. The electrospinning device may be designed and operated such that the nanofibers are already dry when they contact the paper web. Therefore, in accordance with some embodiments, no additional energy is required to dry the nanofiber web after application. In accordance with a more particular aspect of this embodiment, there may be from about 5 to 15 drying cylinders installed before the electrospinning device and from about 10 to 100 drying cylinders after the electrospinning device. Furthermore, the electrospinning device may be positioned relative to the paper machine so as to apply the nanofibers to either surface of the forming paper web. More than one electrospinning device may be employed to apply nanofibers to both sides of the forming paper web.

In accordance with other embodiments of the present invention, bonding between the nanoweb and cellulose paper web can be improved by providing a binder between the two webs. Binders, useful in adhering the nanoweb to the paper web, are not particularly limited so long as they are compatible with the materials used in forming the nanoweb. Particularly, the useful binders include polyvinyl alcohol and polyvinyl pyrrolidone. The binder may be applied to the forming paper web by any conventional technique known to those skilled in the art. In accordance with the particular embodiments of the present invention, the binder composition is sprayed onto the surface of the cellulose fiber web. In accordance with particular aspects of the present invention, the binder is applied to the cellulose web before application of the nanoweb.

The binder compositions, having the appropriate concentration and viscosity, can be determined by one of ordinary skill in the art. The glass transition temperature for particularly useful binders is typically between about 10 and 100° C., more particularly between about 20 and 50° C. The binder compositions may comprise one or more adjunct materials or optional ingredients to improve the application process or binding of the nanoweb and the paper web. The amount of binder applied is not particularly limited but will usually be between about 0.05 and about 15 gsm (0.01 lb/1000 ft² and about 3 lb/1000 ft²) based on dry weight, more particularly from about 0.05 to about 2 gsm (0.01 lb/1000 ft² to about 0.4 lb/1000 ft²).

Nanofibers useful in accordance with the present invention typically have an average diameter of less than about 1000 nanometers (nm). In accordance with certain embodiments, the average diameter of the fibers is from about 50 to about 700 nm, more particularly from about 60 to about 500 nm, and, in particular aspects of the invention, from about 200 to about 300 nm. One skilled in the art will appreciate that the fiber average diameter accounts for variations along the length of the fiber and the fact that the cross sectional shape of the fibers may have various forms such as circular, elliptical, flat or stellato.

The nanofibers may be applied at a coating weight of from about 0.05 to about 20 gsm (0.01 lb/1000 ft² to about 4 lb/1000 ft²), more particularly from about 0.1 to about 10 gsm (0.02 lb/1000 ft² to about 2 lb/1000 ft²), still more particularly from about 0.2 to about 5 gsm (0.04 lb/1000 ft² to about 1 lb/1000 ft²) and, in accordance with particular embodiments of the invention, from about 0.5 to about 2 gsm (0.1 lb/1000 ft² to about 0.4 lb/1000 ft²) based on dry weight. Accordingly, in accordance with certain embodiments, the coat weight of the nanofibers may be about 10 times less than conventional coating materials.

Various fiber-forming compositions can be used in forming nanofibers in accordance with the present invention. Materials such as biopolymers (collagen, fibrinogen), natural polymers (alginate, cellulose derivatives, etc.), chitosan, bicompatible polymers, polycaprolactone, polyethylene oxide and the like may be used. Furthermore, the following materials may also be used: aluminum oxide, ferrofluid composite, silica, aluminosilicate, organosilicas, TiO₂ (anatase and rutile), TiN, Nb₂O₅, Ta₂O₅, TiN oxide-fluorinated and non-fluorinated, indium, tin oxide, V₂O₅, mixed oxides (Mn, Ga, Mo, W, Zn), PEO/Laponite™. Laponite™ is a commercially-available synthetic hectorite.

The fiber-forming composition may comprise polymer provided in a liquid state by any means such as by dissolving in a solvent or melting the polymer. Polymer materials that can be used in the polymeric compositions of the invention include both addition polymer and condensation polymer materials such as polyolefin, polyacetal, polyamide, polyester, cellulose ether and ester, polyalkylene sulfide, polyarylene oxide, polysulfone, modified polysulfone polymers and mixtures thereof. Preferred materials that fall within these generic classes include polyethylene, polypropylene, poly (vinylchloride), polymethylmethacrylate (and other acrylic resins), polystyrene, and copolymers thereof (including ABA type block copolymers), poly (vinylidene fluoride), poly (vinylidene chloride), polyvinylalcohol in various degrees of hydrolysis (87% to 99.5%) in crosslinked and non-crosslinked forms.

Block copolymers are also useful in accordance with certain embodiments of the invention. With such copolymers the choice of solvent swelling agent is important. The selected solvent is such that both blocks were soluble in the solvent. One example is an ABA (styrene-EP-styrene) or AB (styrene-EP) polymer in methylene chloride solvent. If one component is not soluble in the solvent, it will form a gel. Examples of such block copolymers are Kraton® type of AB and ABA block copolymers including styrene/butadiene and styrene/hydrogenated butadiene (ethylene propylene), Pebax® type of epsilon-caprolactam/ethylene oxide, Sympatex® polyester/ethylene oxide and polyurethanes of ethylene oxide and isocyanates.

Addition polymers like polyvinylidene fluoride, syndiotactic polystyrene, copolymer of vinylidene fluoride and hexafluoropropylene, polyvinyl alcohol, polyvinyl acetate, amorphous addition polymers, such as poly (acrylonitrile) and its copolymers with acrylic acid and methacrylates, polystyrene, poly (vinyl chloride) and its various copolymers, poly (methyl methacrylate) and its various copolymers, can be solution spun with relative ease because they are soluble at low pressures and temperatures.

The fine nanofiber formation can be improved by the presence of oleophobic and hydrophobic additives, as these additives form a protective layer coating or penetrate the surface to some depth to improve the nature of the polymeric material. The important characteristics of these materials are the presence of strong hydrophobic groups that can have oleophobic character. Strongly hydrophobic groups include fluorocarbon groups, hydrophobic hydrocarbon surfactants or blocks and substantially hydrocarbon oligomeric compositions. These materials are manufactured in compositions that have a portion of the molecule that tends to be compatible with the polymer material. These sections of the polymer can form a physical bond or an association with the polymer, while the strongly hydrophobic or oleophobic groups forms a protective surface layer that can reside on the surface or become alloyed with or mixed with the polymer surface layers.

Polymers useful in forming the fibers of the nanoweb in accordance with certain embodiments have a melt index of between about 0.5 to about 250 g/10 min, more particularly between about 50 and about 150 g/10 min and in accordance with certain embodiments between about 50 and about 100 g/10 min. Melt Index can be determined in accordance with ASTM D1238.

In accordance with particular embodiments of the invention, a paper or paperboard coated with nanofibers as described herein may exhibit the following properties:
1. Extremely high opacity and covering potential of the paper or paperboard surface at low coat weight.
2. Substantially improved print gloss due to ink holdout, absorption, and setting rates on the very thin-layered nanoweb.
3. Ability to uniformly cover the surface of paper and develop high smoothness regardless of the roughness of the base paper. For example, a Parker smoothness of 2.0 microns was achieved, without calendering, by applying a nanoweb on the surface of a paper having Parker smoothness of 6.0-9.0 microns.

These advantages allow the use of lightly calendered paper or paperboard, thus preserving stiffness while providing good printing properties.

The base sheet is typically formed from fibers conventionally used for such purpose and, in accordance with the particular embodiments, includes unbleached kraft pulp. The pulp may consist of hardwood or softwoods or a combination thereof. The basis weight of the cellulose fiber layer may range from about 10 to about 700 gsm, and more particularly, from about 100 to about 600 gsm. The base sheet may also contain organic and inorganic fillers, sizing agents, retention agents, and other axillary agents as is known in the art. The final paper of the invention can contain one or more cellulose-fiber layers, nanoweb layers and, in accordance with certain embodiments, binder layers.

The present invention in accordance with certain embodiments, provides one or two-sided coated paper or paperboard for printing or packaging whose gloss value after the coating and finishing processes measured, according to TAPPI 5467, higher than about 75% and whose Parker smoothness value measured according to TAPPI paper and pulp test method No. 5A is lower than about 2-3 microns. The geometric mean stiffness value L measured according to TAPPI 8143 A for commercial board can satisfy equation (1) below and for particular examples of paper or paperboard produced in accordance with aspects of the invention can satisfy equation (2) below.
L=0.0105x²−1.6049x+70.867 COMMERCIAL BOARD (1)
L=0.015x²−1.7x+90 EXAMPLE OF INVENTIVE BOARD (2)
Where L=geometric mean of stiffness (g−cm), and x=basis weight (g/m²)

Thus this invention can provide a novel one or two-sided coated paper or paperboard for printing or packaging which has a stiffness satisfying the above equation (2) and be incomparable to any conventional coated paper products, and, moreover, in accordance with certain embodiments the paper or paperboard may exhibit high gloss higher than 75%), high smoothness (lower than Parker of 2.0-3.0 microns), and excellent ink receptivity.

The composite paper web comprising cellulose fibers and nanofibers may further be provided with one or more coatings. Typically, a top coating may be provided over the nanofiber layer. The top coating may contain conventional components to improve certain properties of the sheet such as pigments, binders, fillers and other special additives. The nanofiber layer provides a very smooth, thin layer that holds out any top coating. Due to the unique uniformity of the nanofiber layer and the high specific surface area of the nanofibers, significant improvements in print properties may be achieved. The top coat, when present, may be applied at much lower coat weights than conventional coatings and yet provide similar print properties. Accordingly, the top coat weight may be about 5 to 30 gsm. By contrast, conventional coated paper typically requires about 25 to 60 gsm coat weight to provide comparable surface properties. The composite web may also be coated on the cellulose web side of the sheet.

The present invention is illustrated in more detail by the following non-limiting examples.

### EXAMPLES

Formulations were developed for applying the nanoweb on the surface of the paper by the electrospinning process.

### Formulation Examples

| | | By weight |
|---|---|---|
| 1) | PVOH Elvanol 71-30-- | 8-14% |
| | Surfactant Triton X-100- | 0.05-0.1% |
| | Plastic pigment / Omnova 2203- | 8-18% |
| | ME cross-linker Cymel 385- | 8-18% |
| | Water | Balance |
| 2) | Elvanol 71-30 | 8-14% |
| | Calcium Carbonate | 5-20% |
| | Cymel 385 | 8-15% |
| | Triton X-100 | 0.1-0.2% |
| | Water | Balance |
| 3) | PVOH Elvanol 71-30 | 8-14% |
| | Polytetrafluoroethylen PTFE TE 3667N | 1-5% |
| | MF cross-linker Cymel 385 | 8-15% |
| | Surfactant Triton X-100 | 0.1-0.2% |
| | Water | Balance |
| 4) | PVOH Elvanol 71-30- 10% | 8-14% |
| | Surfactant Triton X-100 | 0.1-0.2% |
| | MF cross-linker Cymel 385 | 8-15% |
| | Water | Balance |

Coating:

The nanoweb coating formulation is applied with an electrospinning device using voltage 5-100 KV and electrical current 50-400 microampere.

Finish by Calendering:

Improvement of the paper surface can be achieved by calendering. For the proposed multi-layer paper structure according to this invention, calendering should be much less intensive to develop the same printing properties as are characteristic for conventionally coated paper.

Base sheets produced with different levels of calendering could be coated with a base coating and a top coating. The base coat of one group of samples may be electrospun fibers produced from a polymer solution according to the following formulation:

| Raw Material | Percent by Weight Wet |
|---|---|
| Polyvinyl alcohol (PVOH) | 10% |
| Surfactant - Triton X - 100 | 0.5% |
| Plastic pigment - Omnova 2203 | 10% |
| MF cross-linker Cymel 385 | 10% |
| Water | Balance |

The nanofiber formulation can be applied with an electrospinning device at a voltage of about 80 KV and an electric current of about 50-400 microampere. The resulting nanofibers are expected to have an average diameter of about 200 nm. The nanofibers may be applied to an unbleached board substrate having a basis weight of about 114 pounds per 3,000 square feet. The nanofibers may be applied at a coat weight of about 5 gsm. In accordance with this example, the nanofibers could be applied in the drying section of the paper machine at a dryness level of the base stock prior to coating of about 60%.

On the control samples, conventional coating may be applied as a base coating. The top coating in both cases would be a conventional coating. A typical top-coating formulation is indicated below:

| Raw Material | Parts |
|---|---|
| Clay | 50 |
| Calcium Carbonate | 50 |
| Styrene Butadiene Latex | 18 |
| Plastic Pigment | 7 |

The top coating may be applied at a coat weight of about 15 grams per square meter.

It is expected that stiffness and printing properties characterized by print density and print gloss would be improved. Uniformity of printing image on print mottle is expected to improve substantially with the composite paper of the present invention.

Papers produced in accordance with the invention are generally smoother than conventional papers when precalendered at the same pressure. Notably, the differences in smoothness are more pronounced at lower precalendering pressures. The method of the present invention can be used to produce papers having PPS smoothness values of 1.8 or less at relatively low precalendering pressures such as 1400 psi or lower, more particularly 800 psi or lower and in accordance with certain embodiments at 200 psi or lower.

Print gloss of papers produced in accordance with some embodiments of the present invention is less dependent on the density of the sheet. In accordance with certain aspects of the present invention, coated papers can be prepared having a density of 11.0 pounds/3000 ft²/mil or less that have a print gloss of 80 or higher, more specifically that have a print gloss of 85 or higher.

In accordance with the present invention, papers can be produced having a density of 11.0 pounds/3000 ft²/mil or less with a PPS smoothness of 1.8 or less.

Having described the invention in detail, it will be apparent that modifications and variations are possible without departing from the scope of the invention defined in the appended claims.

What is claimed is:

1. A method of coating a paper or paperboard comprising the steps of:
contacting a plurality of meniscus initiators with a fiber-forming composition such that menisci form in the fiber-forming composition adjacent to the meniscus initiators, thereby forming areas of concentrated charge corresponding to the menisci in the fiber-forming composition,
forming fibers at the areas of concentrated charge by electrostatically drawing the fiber-forming composition toward a first electrode,
depositing said fibers on a web of cellulose paper fibers positioned between said fiber-forming composition and the first electrode.

2. The method of claim 1 wherein the coat weight of the cellulose fiber web is from about 10 to about 700 gsm.

3. The method of claim 1 wherein the meniscus initiators comprise rods.

4. The method of claim 3 wherein the rods have diameters between about 0.2 mm and about 10 mm.

5. The method of claim 1 wherein the coat weight of the nanofibers is between about 0.1 and about 10 gsm.

6. The method of claim 5 wherein the paper or paperboard comprises a first side comprising primarily cellulose paper fibers and a second side comprising primarily nanofibers.

7. The method of claim 1 wherein said fiber-forming composition comprises a material selected from the group consisting of polymers, metaloxides and composites thereof.

8. The method of claim 7 wherein the fiber-forming composition comprises a polymer selected from the group consisting of polyolefins, polyacetals, polyamides, polyesters, cellulose ethers and esters, polyalkylenes sulfides, polyarylene oxides, polysulfones, modified polysulfone polymers and mixtures thereof.

9. The method of claim 8 wherein the fiber-forming composition comprises polyvinyl alcohol.

10. The method of claim 7 wherein said nanofibers have an average diameter in the range from about 50 to about 700 nm.

11. The method of claim 1 wherein the nanofibers are applied to the web of cellulose paper fibers in a drying section of a paper machine.

12. A paper or paperboard produced in accordance with claim 1.

13. A method of applying nanofibers to a paper or paperboard comprising:
forming a web of cellulose fibers on a paper machine, and
coating the web of paper fibers with a plurality of nanofibers wherein the nanofibers are formed by an electrospinning process comprising forming a meniscus in a fiber-forming composition by flowing the fiber-forming composition over a meniscus initiator,
subjecting the fiber-forming composition to an electrostatic force thereby initiating the formation of a nanofiber at the meniscus.

14. The method of claim 13 wherein the meniscus initiators comprise rods.

15. The method of claim 13 wherein the coat weight of the nanofibers is between about 0.1 and about 10 gsm.

16. The method of claim 13 wherein said fiber-forming composition comprises a material selected from the group consisting of polymers, metaloxides and composites thereof.

17. The method of claim 16 wherein the fiber-forming composition comprises a polymer selected from the group consisting of polyolefins, polyacetals, polyamides, polyesters, cellulose ethers and esters, polyalkylenes sulfides, polyarylene oxides, polysulfones, modified polysulfone polymers and mixtures thereof.

18. The method of claim 13 wherein said nanofibers have an average diameter in the range from about 50 to about 700 nm.

19. The method of claim 13 wherein the nanofibers are applied to the web of cellulose paper fibers in a drying section of a paper machine.

20. A paper or paperboard produced in accordance with claim 13.
